(19) United States
(12) Patent Application Publication
(10) Pub. No.: US 2024/0218183 A1
(43) Pub. Date: Jul. 4, 2024

(54) POLYMER MODIFIED OXIDIZED ASPHALT COMPOSITION AND METHOD

(71) Applicant: ASPHALT SCIENCES LLC, RENO, NV (US)

(72) Inventors: Joseph Randall Bruns, Scurry, TX (US); Sumer S. Lucas, Waxahachie, TX (US)

(21) Appl. No.: 18/092,292

(22) Filed: Dec. 31, 2022

(51) Int. Cl. C08L 95/00

(52) U.S. Cl. CPC C08L 95/00; C08L 2555/64; C08L 2555/86

(57) ABSTRACT

A method for generating a polymer modified oxidized asphalt is described. The method includes receiving a plurality of polymerizing concentrate components including an aromatic oil, a saturated polymer, an oxidized polymer, and polyisobutylene (“PIB”). The polymerizing concentrate components are then heated to between 350° F. and 450° F. with mixing for between 1 and 7 hours to generate a polymerizing concentrate. The method then mixes the polymerizing concentrate with oxidized asphalt and heated to between 350° F. and 450° F. with mixing for between 15 minutes and 1 hour to generate the polymer modified oxidized asphalt.

### FIELD

This invention relates to a polymer modified oxidized asphalt composition and method. More specifically, the invention relates to production of a polymerizing concentrate that solubilizes hydrogenated polymers in oxidized roofing fluxes and adding the polymerizing concentrate to oxidized roofing fluxes to generate polymer modified oxidized roofing flux compositions.

### BACKGROUND

Asphalt is a complex colloid of asphaltenes suspended in oils and resins commonly referred to as the maltene fraction. The chemical composition of the maltene fraction has a significant effect on the penetration, softening point, and viscosity of asphalt as lighter components are converted into larger molecules.

Crude oils are a naturally occurring complex mixture composed relative amounts and characteristics of different hydrocarbons. There are various systems for classification of crude oil. One such system classifies oil as paraffin, asphaltic (naphthenic), or mixed-based depending upon the type of hydrocarbon present in the crude.

Petroleum asphalt may not conform to paving or industrial grade specifications and air blowing may be used to prepare the asphalt material for paving and roofing applications. The air blowing process includes bubbling air through an asphalt mixture to oxidize some of the constituents. Additionally, air blowing may also include the use of a catalyst to accelerate reactions. The oxidized roofing asphalt resulting from industrial air blowing and/or catalyst processes has somewhat predictable physical properties, e.g., a penetration depth @77° F. of at least 15 dmm and a softening point of 190° F.-235° F.

However, batches of oxidized roofing asphalt do not always conform to the desired physical properties in one or more category (i.e., penetration depth and softening point). Such batches must then be re-processed and/or mixed with other batches to achieve the desired physical properties. Such additional processing adds time and expense (and potentially waste) to the process of generating oxidized roofing asphalt.

The process of oxidizing asphalt for use as roofing coatings lowers the penetration depth and raises the softening point of the non-oxidized asphalt feedstock. In so doing, the aromatics and resins comprising the non-oxidized asphalt feedstock are driven toward asphaltenes of larger molecular weight and the oxidized asphalt is made stiffer, harder, and more brittle. While these properties are generally desirable in roofing coatings, the resulting coating adheres to shingle base layers in the high temperatures experienced by shingles on a roof (up to 176° F.) and such shingles are sensitive to high winds and impacts, i.e., hail.

Modified asphalt coatings incorporating styrenic block polymers, e.g., SBS, have demonstrated greater impact resistance such as a class 4 impact resistance. Additionally, modified asphalt coatings that include SBS are more likely to reseal and self-heal when high winds unseal a shingle without creasing or cracking.

However, such polymer modified asphalt (“PMA”) shingles are generated from non-oxidized asphalt because SBS is not readily soluble in oxidized asphalt. Also, PMAs have lower softening points. The handling of non-oxidized asphalt to generate PMA shingles requires shingle factories that are entirely separate from those utilizing oxidized asphalt. Alternatively, factories utilizing oxidized asphalt have to be shut-down and their lines of oxidized asphalt have to be flushed before the non-oxidized asphalt may be utilized. Further, the higher softening point of the PMA results in shingles that commonly require cooler temperatures for installation, else the PMA shingles are tracked and partially or completely destroyed by the laborers installing them. The requirement of cooler temperatures for installation may limit installation to times other than the heat of the day, seasons other than summer, or require water cooling during installation.

### SUMMARY

A polymer modified oxidized asphalt composition and method of generating such is described. The method begins by generating a polymerizing concentrate by mixing an aromatic oil, a saturated polymer, an oxidized polymer, and polyisobutylene (“PIB”), with heating to between 350° F. and 450° F. for between one (1) and seven (7) hours to generate the polymerizing concentrate. The polymerizing concentrate is then added to oxidized asphalt with heating to between 350° F. and 450° F. and mixing for between 15 minutes and 1 hour to generate the polymer modified oxidized asphalt.

In one embodiment, the aromatic oil, saturated polymer, oxidized polymer, and PIB are heated to between 370° F. and 410° F. to generate the polymerizing concentrate.

In one embodiment, the aromatic oil, saturated polymer, oxidized polymer, and PIB are mixed for 1.5 hours to 2.5 hours to generate the polymerizing concentrate.

In some embodiments, the PIB includes an average molecular weight ranging from 200 g/mol to 110,000 g/mol. In one embodiment, the PIB includes an average molecular weight ranging from 800 g/mol to 2,300 g/mol.

In some embodiments, the polymerizing concentrate includes 50% to 75% by weight aromatic oil, 5% to 15% by weight saturated polymer, 1% to 5% by weight oxidized polymer, and 20% to 30% by weight PIB.

In some embodiments, 2% to 20% by weight of the polymerizing concentrate is added to the oxidized asphalt. In one embodiment 5% to 12% by weight of the polymerizing concentrate is added to the oxidized asphalt.

### FIGURES

The present invention will be more fully understood by reference to the following drawings which are presented for illustrative, not limiting, purposes.

FIG. 1 shows an illustrative method for producing polymer modified oxidized asphalt (“PMOA”) shingles

FIG. 2 shows a prior art method for polymer modified asphalt (“PMA”) shingle production.

FIG. 3 shows a schematic method for generating a polymerizing concentrate and PMOA.

FIG. 4 shows a method for correcting an overblow of oxidized asphalt for roofing flux.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the methods and compositions described herein may vary as to configuration and as to details. Additionally, the methods may vary as to details, order of the actions, or other variations without departing from the illustrative methods disclosed herein.

There are challenges to generating both oxidized asphalt shingle roofing coatings and polymer modified asphalt (PMA) shingle roofing coatings.

Oxidized asphalt feedstocks must meet specific requirements. These requirements include producing coating asphalts for roofing shingles that meet the softening point requirements of 190° F. or greater and a penetration of 15 dmm or greater as described in ASTM D3462, which is hereby incorporated by reference. Another requirement includes lowering the asphalt feedstock penetration into a range where the granules may be properly pressed without becoming too brittle. Yet another requirement includes raising the melt viscosity of the asphalt feedstock so that when filler is added the filled coating viscosity allows a roofing shingle process to run at high speeds. A further requirement is to create a shingle that will perform over many years on a roof in spite of being exposed to sun, high temperatures, high winds, rain, and even hail.

However, oxidized asphalt coatings cannot generate class impact resistant shingle coatings and the resulting shingles are more susceptible to damage from hail and high winds than PMA shingles. Additionally, the oxidation process may result in an overblown asphalt with a penetration below the ASTM D3462 requirements of 15 dmm and/or a softening point above the ASTM D3462 requirement. Generally, the addition of oils as a secondary process step to modify overblown roofing coating is not a common practice, because the resulting asphalt flux has a penetration that is increased above 15 dmm, but the softening point typically drops below the ASTM D3462 requirements of 190° F. Furthermore, oil modified coatings often cause significant staining on roofing shingles as these oil components will move to the surface and discolor the granule surfacing. Also, the rate of penetration changes with temperature with the addition of oils that result in excessive scuffing of the roof granules from the shingles due to foot traffic during installation in hot weather. Previously, the only recourse was the addition of large amounts of blown oxidized asphalt to achieve an acceptable average penetration depth and softening point as required by ASTM D3462. Note, even this recourse was not certain to correct the overblown oxidized asphalt, and may result in a batch of oxidized asphalt that must be disposed of or used for another purpose.

In some embodiments, the methods and compositions presented herein have been developed to correct overblown oxidized asphalt feedstocks, improve the operating flow rate of the resulting corrected oxidized asphalt roofing coating, and improve the granule adhesion of the corrected oxidized asphalt roofing coating.

PMA shingle coatings are generated from non-oxidized asphalt feedstocks and elastomers, particularly Styrene-Butadiene-Styrene block copolymer (“SBS”). Mixtures of PMA shingle coatings containing SBS are thermally unstable, and subject to degrade over relatively short periods of time. Further, non-oxidized asphalt feedstocks are generally immiscible with oxidized asphalt, necessitating restrictive and cost-prohibitive practices when receiving both oxidized asphalt and non-oxidized asphalt by a single shingle coating system (i.e., factory or plant). Thus, producing PMA shingles typically requires PMA shingle production facilities that are isolated from, and frequently entirely separate from, facilities producing standard oxidized shingles. Otherwise, PMA shingle production requires factories utilizing oxidized asphalt to shut down and flush their lines of oxidized asphalt before the non-oxidized asphalt may be utilized.

As a consequence of both the thermal instability and incompatibility with oxidized asphalt, PMA is typically limited to use in dedicated PMA shingle production facilities that are within relatively close proximity to a PMA production facility or produce their own PMA for coating shingles. To date, PMA shingle production facilities are significantly less prevalent than standard oxidized shingle production facilities, creating a further inefficiency in existing systems, PMA shingles travel further on average from their point of origin to their point of consumption than standard oxidized shingles. Further, the higher softening point of the PMA shingle coatings results in shingles that require cooler temperatures for installation, prevent spoilage during installation.

In some embodiments, the methods and compositions presented herein overcome the drawbacks of standard oxidized shingle coatings by incorporating the benefits of typical PMA coatings while avoiding the limitations of both the PMA production process and of PMA shingles. The methods and compositions presented herein achieve this by successfully incorporating synthetic rubber polymers into oxidized asphalt roofing fluxes to generate polymer modified oxidized asphalt (“PMOA”).

PMOA shingles provide class 4 impact resistance without the temperature sensitivity of PMA shingles providing class 4 impact resistance. PMOA may incorporate natural products, such as terpenes. PMOA lacks any polycyclic aromatic hydrocarbons (“PAHs”), prolonged exposure to which is known to cause cataracts, kidney and liver damage, and jaundice. PMOA is less viscous than oxidized roofing flux complying with ASTM D3462 requirements, allowing for faster flow and shingle production rates. PMOA provides greater granule adhesion than oxidized roofing flux complying with ASTM D3462 requirements, allowing for up to 25% less PMOA shingle coating per shingle while still satisfying granule adhesion requirements. The reduced amount of material required to make a PMOA shingle provides a cascade of benefits: such as, reduced production cost and reduced per shingle per mile transportation cost. PMOA can be produced in existing oxidized asphalt shingle production facilities without shutdowns or purges of asphalt. Further, production of PMOA shingles in existing oxidized asphalt shingle production facilities reduces the average travel distance of a polymer modified shingle from the point of origin to the point of consumption as compared to existing PMA shingles.

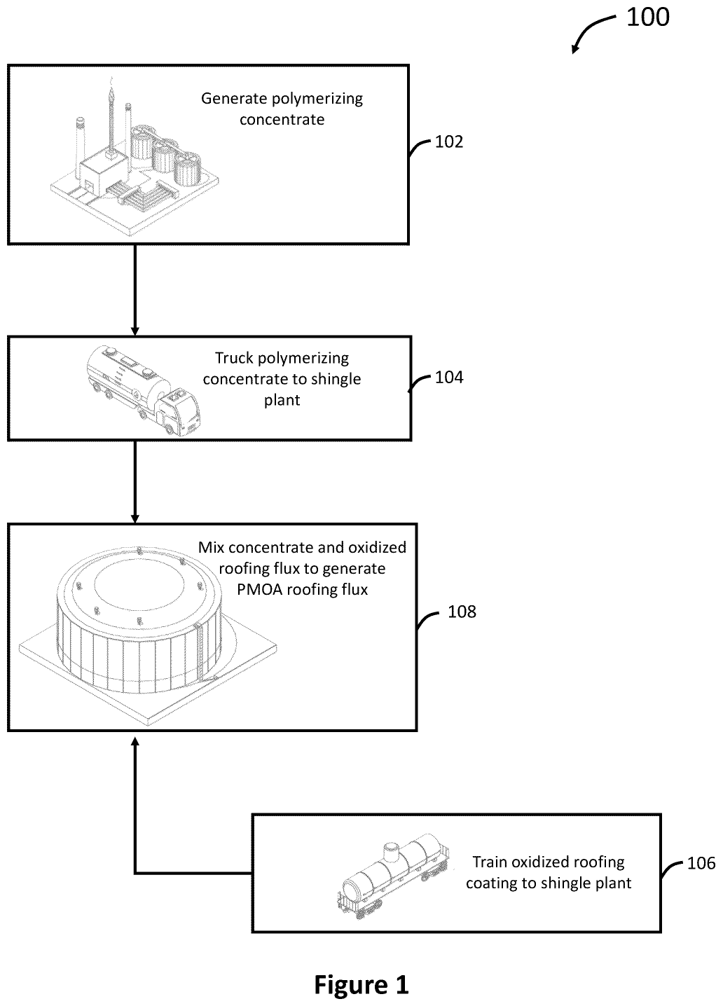

With reference now to FIG. 1, there is shown a method 100 for producing PMOA shingles. PMOA is produced by the addition of a polymerizing concentrate to oxidized asphalt. The polymerizing concentrate is produced at a specialty plant in step 102. In a typical PMOA shingle production run, one truckload of the polymerizing concentrate is transported from the facility generating the polymerizing concentrate to the oxidized shingle production facility (also the PMOA shingle production facility) at step 104. Simultaneously, oxidized roofing asphalt is received by train at the oxidized shingle production facility (also the PMOA shingle production facility) at step 106. The polymerizing concentrate is then added to the oxidized asphalt to generate PMOA at step 108, where the PMOA can then be used as a shingles coating.

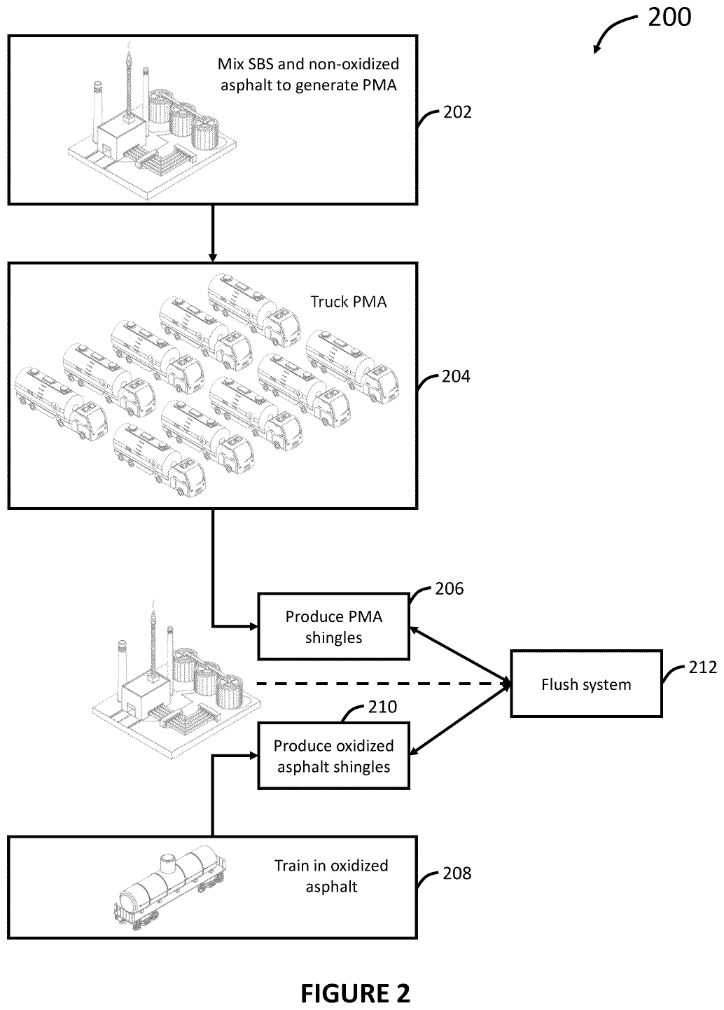

FIG. 2 shows a prior art PMA shingle production method 200. The PMA is produced at a specialty plant in step 202. A run of this method 200 requires an illustrative 10 truckloads of PMA to be delivered to a PMA shingle production facility at step 204. Additionally, the thermal instability of PMA in method 200 prevents its transport in excess of approximately 4 hours by truck, limiting the number of PMA shingle production facilities than could be supported by a single PMA production facility. Upon receiving the truckloads of PMA, the PMA shingle production facility completes a batch run of PMA shingles at step 206. The PMA shingle production facility may also produce standard oxidized shingles—so the facility receives the oxidized roofing coating by train at step 208. The method then continues and produces oxidized asphalt shingles in a semi-continuous flow at step 210. In the illustrative embodiments, the shingle production facility must flush the lines of its system both before and after a PMA shingle run at step 212.

The PMOA Method 100 in FIG. 1 is a significant improvement over prior art method 200 because certain production steps are eliminated with the PMOA method 100 and because of the thermal stability of the reactants in the PMOA method. More specifically, with the PMOA method 100, step 204 is eliminated. Step 204 requires 10 truckloads of PMA to be delivered to a PMA shingle production facility. Elimination of step 204 in the PMOA shingle production method 100 represents a further reduction in transport costs associated with polymer modified shingle production. Additionally, the thermal stability of the polymerizing concentrate from method 100 enables its transport over vastly greater distances and allows one polymerizing concentrate plant to support a correspondingly larger number of shingle production facilities. Furthermore, the PMOA shingle production of method 100 also does not require any system flushing between runs as shown in step 212.

Unless otherwise stated, the following terms used in this application, including the specification and claims, have the definitions given below. It must be noted that as used in the specification and the appended claims, the singular forms “a,” “an,” and “the” include plural references unless the context clearly dictates otherwise.

“Optional” or “optionally” means that the subsequently described event or circumstance may, but need not, occur, and that the description includes instances where the event or circumstance occurs and instances in which it does not.

The terms “those defined above” and “those defined herein” when referring to a variable incorporates by reference the broad definition of the variable as well as preferred, more preferred, and most preferred definitions, if any.

The term “asphalt” is defined by the American Society for Testing and Material (ASTM) as a dark brown to black cementitious material solid or semi solid in consistency, in which the predominating constituents are bitumens which occur in nature as such or are obtained in residue in refining petroleum. Asphalt is a constituent of most crude petroleum. More generally, the present compositions and methods described herein consider asphalt a colloidal system. Asphalt is composed of asphaltenes and maltenes. The relative amounts of asphaltenes and maltenes determine the physical and chemical behavior of any given asphalt. Generally, asphalt occurs naturally in a non-oxidized form, however asphalt may be subjected to certain oxidative processes to generate oxidized asphalt.

The term “bitumen” refers to a generic term that according to ASTM relates to a mixture of hydrocarbons of natural or pyrogenous origin, or a combination of both, frequently accompanied by their non-metallic derivatives, which may be gaseous, liquid, semisolid, or solid and which are completely soluble in carbon disulphide. In commercial practice the term bitumen is used for the semisolid or solid bitumen which includes asphalts, tars and pitches. Tars and pitches are obtained by destructive heat action on crude oil, coal and other organic materials. For the purposes of this disclosure, bitumen is understood to be composed of asphaltenes and maltenes, in contrast to some industry terminology that identifies asphalt, instead of bitumen, as being composed of asphaltenes and maltenes. The relative amounts of asphaltenes and maltenes in the bitumen determine the physical and chemical behavior of any given asphalt derived therefrom.

Generally, the term “flux” refers to an asphaltic residue having a larger penetration depth and lower softening point than paving asphalt. Such asphalt flux may exist in isolation (or be modified with certain additives and/or polymers) as a roofing coating and thus be termed “roofing flux.” Asphalt flux may be used to soften asphalt to a desired consistency. The asphalt flux may include original asphalt feedstock that has not been oxidized or blown asphalt feedstock that has been oxidized. Additionally, the asphalt flux may also include other compounds that may be used to soften the asphalt. More specifically, the term “flux” refers to an oil or asphalt component having a COC flash in excess of 550° F.

Oxidized roofing flux meets the physical property requirements of ASTM 3462. Generally, roofing flux is softer than paving asphalt, and may be categorized as AC-2.5 or Paving Grade (PG) 46.

The term “asphaltene(s)” refers to the portion of asphalt that is naphtha insoluble, so that in excess of naphtha the asphaltenes are insoluble. The asphaltenes may represent up to 50% of asphalt, in which a major portion of total oxygen, nitrogen, sulfur, nickel and vanadium are concentrated. Asphaltenes are brown to black amorphous solids. Then have carbon/hydrogen ratios of 0.81-1.00 which indicates they are aromatic in nature. Their molecular weight ranges from 500-7000 g/mol.

The term “maltene” refers to the naphtha soluble portion of asphalt. The maltene fraction is free of asphaltenes and carbenes. The maltene carbon/hydrogen ratio is in the range of 0.6-0.75 which indicates that the molecular structure includes aliphatic chains or saturated rings. The maltene fraction includes resins and oils. The molecular weights are in the range of 500-1500 g/mol.

The term “resins” refers to cyclic aromatic compounds.

The term “oils” refers to saturated hydrocarbons having appreciable wax content.

The term “aromatic oils” refers to oils predominantly comprising aromatic hydrocarbon compounds and including 10% or less saturated hydrocarbon compounds by mass. The aromatic hydrocarbon compounds may include one or more aromatic carbon rings containing essentially no hetero-atoms (i.e., trace amounts only). The saturated hydrocarbon compounds may be linear or branched organic molecules of low polarity containing essentially no hetero-atoms (i.e., trace amounts only).

The term “terpene” refers to hydrocarbon natural products having the formula (C₅H₈)ₙ, where n>1.

The term “carbenes” refers to the highest carbon content fraction of asphalt. Carbenes are insoluble in carbon tetrachloride. Carbenes, if present, occur in trace amounts.

The term “asphalt feedstock” refers to both oxidized and non-oxidized asphalt starting materials, and is used interchangeably with the terms “bitumen,” “asphalt bitumen,” and “asphalt bitumen feedstock.”

The term “blown asphalt” refers to the process of changing the properties of asphalt feedstock by oxidation with atmospheric oxygen and, typically, high temperatures to generate “oxidized asphalt.” Petroleum asphalts are obtained during crude oil production as atmospheric/vacuum residues or as extracts from lubricating oil production. The properties of these asphaltic materials are greatly dependent on the nature of crude oil and the refinery processes employed. These asphalts do not necessarily conform to roofing requirements. To improve their properties, asphalts are oxidized by air blowing. Asphalts used for roofing and coating applications require a material with lower penetration and a higher softening point. This is achieved by air blowing at a high temperature.

Air blowing of asphalt is a process to increase the softening point with low temperature susceptibility. Air blowing is a heterogeneous reaction between gas and liquid phases. When an asphalt is oxidized, its specific gravity and hardness is increased, and the ductility of the product becomes much lower. Factors which influence the rate of hardening are: construction and design of the reactor, characteristics of feed, temperature and blowing, air rate, and degree of dispersion and catalysts.

Various physical and chemical changes occur during air blowing and these physical changes are measured by determining the penetration and softening point.

The term “penetration” refers to the depth a standard steel needle with a truncated cone penetrates a properly prepared sample of asphalt. Penetration is related to hardness or consistency of the asphalt. The apparatus which permits the needle holder to move vertically without friction and measures the depth of penetration to the nearest 0.1 mm is known as penetrometer. The distance that the needle penetrates in units of tenths of a millimeter is the penetration value. The weight of the needle is 50 g and another 50 g weight is placed on the needle, which results in a 100 g weight. The needle is slowly lowered onto a sample until it just makes contact with the surface of the sample. The dial of the penetrometer is adjusted to zero and the needle is released quickly for the specified period of five seconds and the distance penetrated is measured.

The term “softening point” refers to a measure of temperature in which a steel ball passes through a ring that includes the asphalt sample and falls a distance of 2.54 cm, when the specimen, ball and bath of water/glycerin are heating at a specified rate. A steel ball, 9.54 mm in diameter, is placed in a ball centering guide. The temperature of the water/glycerin bath when the sample and ball fall the specified distance of 2.54 cm is defined as the softening point.

The term “viscosity” refers to the viscosity determination of bitumen or any asphalt derived therefrom at elevated temperatures using a rotational viscometer as described in ASTM D4402, which is hereby incorporated by reference.

The term “Styrenic Block Copolymer” (“SBC”) refers to a large category of thermoplastic elastomers. SBCs possess the mechanical properties of rubbers, and the processing characteristics of thermoplastics. There are two broad classes of SBCs contemplated by this application: saturated and unsaturated. The saturated SBCs have a saturated alkyl backbone linking the styrenic blocks together, while the unsaturated SBCs have an unsaturated or poly-unsaturated backbone linking the styrenic blocks together.

There are six major types of SBCs contemplated by this application, Styrene-Butadiene (“SB”), Styrene-Butadiene-Styrene (SBS) block polymers, Styrene-isoprene-styrene (SIS) block copolymers, Styrene-Ethylene copolymers (“SEC”), Styrene-Ethylene-Butylene-Styrene (“SEBS”), and hydrogenated styrenic block copolymers (HSBC). SB, SBS, and SIS are unsaturated, containing at least one Carbon-Carbon double bond (“C═C”) along their carbon backbone linking the styrenic blocks together. The HSBCs, SEC, and SEBS are saturated, having a saturated alkyl backbone linking the styrenic blocks together. Since the saturated backbone lacks any C═C bonds, or Carbon-Carbon triple bonds, it contains only C—C bonds and Carbon-Hydrogen bonds (“C—H”).

The SBCs can be branched, star, radial, cyclic, linear, diblock, triblock, tetrablock, or multiblock. The branched SBCs have one or more secondary polymer chains linked to a primary backbone at one or more location along the primary backbone. Both star and radial SBCs are subsets of branched SBCs. Star SBCs include a central point within the SBC polymer where four polymer chains link together. Radial SBCs include a central point within the SBC polymer where more than four polymer chains link together.

In some embodiments, the SBC has the general formulae S-B-S(I), or (S-B)ₙ-X (II), and may contain varying amounts of diblock S-B (III) up to 100%. In these formulae, each S independently is a poly(vinyl aromatic), and each B independently is: (1) a saturated alkyl chain or cycloalkyl block, (2) an unsaturated alkylene or cycloalkylene block, or (3) an unsaturated alkyne or cycloalkyne block, n is an integer equal to or greater than 2, and X is the residue of a coupling agent, where the coupling agent can be any di- or polyfunctional coupling agent known in the art.

An exemplary vinyl aromatic monomer is styrene. In some embodiments, the styrene moiety forming the SBCs are substantially pure monomers or a major component in mixtures with minor proportions of other structurally related vinyl aromatic monomer(s), such as o-methylstyrene, p-methylstyrene, p-tert-butylstyrene, 2,4-dimethylstyrene, α-methylstyrene, vinylnaphtalene, vinyltoluene and vinylxylene. Similarly, in some embodiments, the alkyl, cycloalkyl, alkylene, cycloalkylene, alkyne, or cycloalkyne moiety forming the SBC are substantially pure monomers or can contain minor proportions of structurally related alkyls, cycloalkyls, alkylenes, cycloalkylenes, alkynes, or cycloalkynes.

In one embodiment, the unsaturated SBCs include at least two polymer blocks. At least one of those at least two polymer blocks is substantially made of an aromatic vinyl compound and at least one other of the at least two polymer blocks is substantially made of a conjugated diene compound.

In another embodiment, the saturated SBCs include three polymer blocks. One of those three polymer blocks is substantially made of an aromatic vinyl compound, one of the polymer blocks is substantially made of a monoene chain compound, and another of the polymer blocks is substantially made of a second monoene chain compound.

The term “oxidized polymer” refers to polymers including one or more oxygen functional groups. Examples include polyalkyl methacrylates (e.g., polymethyl methacrylate, polyethyl methacrylate, polypropyl methacrylate, polybutyl methacrylate), polycarbonate, oxidized polyethylene, oxidized polypropylene, polyethylene terphthalate (PET or PETE), propylene maleic anhydride copolymer, etc.

The term “asphalt flux” refers to an asphaltic residue having a larger penetration depth and lower softening point than paving asphalt. Such asphalt flux may be in isolation (or modified with certain additives and/or polymers) as a roofing coating and thus termed “roofing flux.” Additionally, such asphalt flux may be used to soften asphalt to a desired consistency. The asphalt flux may include original asphalt feedstock that has not been oxidized or blown asphalt feedstock that has been oxidized. Additionally, the asphalt flux may also include other compounds that may be used to soften the asphalt.

Oxidized roofing flux meets the physical property requirements of ASTM 3462, having a penetration depth greater than 15 dmm, a softening point between 235° F. and 190° F., and a tear strength greater than 16.7 N. Generally, roofing flux is softer than paving asphalt, and may be categorized as AC-2.5 or Paving Grade (PG) 46.

The methods and compositions presented herein include two steps, in which the first step is to generate a polymerizing concentrate by heating a mixture of an aromatic oil, a saturated polymer, an oxidized polymer, and polyisobutylene (“PIB”). The inventors hypothesize that this first step successfully dissolves the saturated polymer and PIB in unwound states in the aromatic oil. For example, the polymerizing concentrate may be generated by receiving 62 parts aromatic oil, 10 parts SEBS, 3 parts oxidized polymer, and 25 parts PIB in a mixing vessel, then heating the vessel to 400° F. with mixing for 2 hours. In this example, the aromatic oil may be Holly Hydrolene LPH (90% heavy aromatic oil and 10% non-aromatic hydrocarbon oils) and include 62% of the polymerizing concentrate by weight; the SEBS may be LCY 7550 (linear SEBS) and include 10% of the polymerizing concentrate by weight; the oxidized polymer may be Honeywell 7686 (high density oxidized polyethylene) and include 3% of the polymerizing concentrate by weight; and the PIB may be TPC 1160 having an average molecular weight of 1,550 g/mol and include 25% of the polymerizing concentrate by weight.

Saturated polymers, such as SEBS, typically dissolve in aromatic oils by folding and clumping into ball-like globules with the styrene functional groups of the end-blocks oriented to the exterior of the ball-like globules and the paraffinic mid-block oriented on the interior of the ball-like globules so that the mid-block is partially shielded from the aromatic oil by the styrene groups. PIB, being an entirely paraffinic polymer, tends to clump when dissolved in an aromatic oil.

The inventors hypothesize that the paraffinic portions of the oxidized polymer, when dispersed in the aromatic oil, seek out the paraffinic mid-block on the interior of the saturated polymer ball-like globules and the paraffinic clumps of PIB, causing the globules of both the saturated polymer and the PIB to expand and morph into an interwoven strand-like construction of the oxidized polymer associated with the saturated polymer, the PIB, or both, which has the practical (although not chemical) effect of functionalizing the mid-block of the saturated polymer and/or the PIB.

The second step is to polymerize oxidized asphalt by dissolving the polymerizing concentrate into the oxidized asphalt to generate polymer modified oxidized asphalt (“PMOA”). For example, the PMOA may be generated by receiving 93 parts oxidized asphalt in a mixing vessel and adding to that 7 parts of the polymerizing concentrate then heating the vessel to 400° F. with mixing for 30 minutes. In this example, the oxidized asphalt may be Atlas Daingerfield coating and include 93% by weight of the resulting PMOA; and the polymerizing concentrate may include 7% by weight of the resulting PMOA. By way of example and not of limitation, the PMOA comprising 7% by weight of the polymerizing concentrate includes 1.75% by weight PIB.

The inventors hypothesize that the interwoven strand-like construction of associated oxidized polymer, saturated polymer, and/or PIB dissolved in the aromatic oil of the polymerizing concentrate dissolves into the oxidized asphalt through interactions between the oxidized asphalt and the oxidized portions of the oxidized polymer, where saturated polymers and PIB in isolation (or the absence of an oxidized polymer), and thus lacking the practical functionalization of the oxidized polymer, fail to dissolve or disperse in a strand-like conformation into oxidized asphalt.

Inventors find support for their hypothesis that the first process step forms interwoven strand-like constructions of the oxidized polymer associated with the saturated polymer and/or the PIB from the observation that the resulting polymerizing concentrate mixture lowers the viscosity of an oxidized asphalt to which it is added, while a concentrate having a non-oxidized polymer substituted for the oxidized polymer (e.g., polyethylene substituted for oxidized polyethylene) does not demonstrate such a corresponding decrease in viscosity of the oxidized asphalt to which it is added.

The PMOA generated by mixing between 7% by weight of the polymerizing concentrate with an oxidized asphalt has a penetration depth ranging from 16 dmm-24 dmm and a softening point ranging from 200° F.-223° F. These characteristics, combined with a decreased viscosity and an improved tack that allows the PMOA to maintain granule adhesion, make the PMOA especially suited for use as a shingle roofing coating.

### Methods of Production

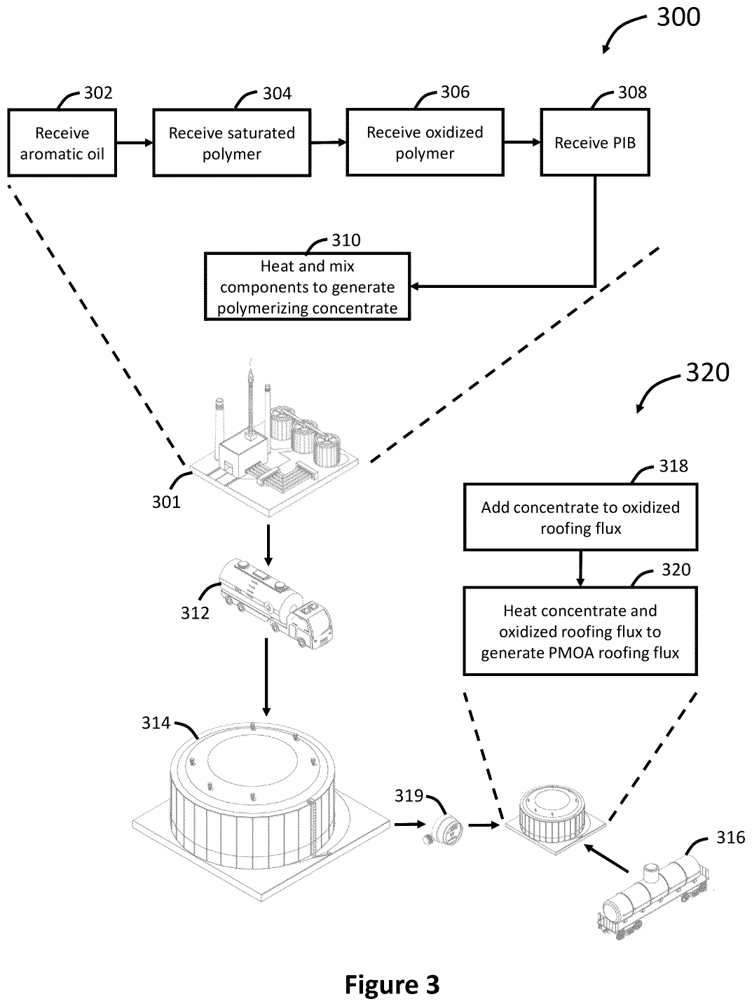

With reference now to FIG. 3, there is shown a detailed schematic method for generating a polymerizing concentrate 300 and PMOA 320. The method for generating the polymerizing concentrate 300 is initiated at block 302 where aromatic oil is received in a mixing vessel at a specialty plant 301 for generating polymerizing concentrates. The aromatic oil may include between 90% and 100% aromatic compounds. In some embodiments, the aromatic oil has a flash point above 500° F. In some embodiments, the aromatic oil has a flash point above 450° F. In one embodiment, the aromatic oil is a terpene comprising more than 99% aromatic compounds. In some embodiments, exemplary aromatic oil includes Tufftrek 4002 (a bio-based aromatic terpene oil), Tufftrek 4008 (a bio-based aromatic terpene oil), Tudalen 5138 (label free aromatic process oil), Holly Hydrolene LPH (heavy aromatic oil treated to remove polynuclear compounds), and any combination thereof.

At step 304, saturated polymer is received in the mixing vessel. Exemplary saturated polymer is SEBS, such as LCY 7550 and LCY 9551. In some embodiments, the SEBS block co-polymer has an average molecular weight between 10,000 and 30,000 g/mol. In some embodiments, the SEBS block co-polymer has an average molecular weight of 20,000 g/mol.

At step 306, oxidized polymer is received in the mixing vessel. Exemplary oxidized polymer may include oxidized polyethylene, oxidized high density polyethylene, oxidized low density polyethylene, oxidized polypropylene, polyalkyl methacrylates (e.g., polymethyl methacrylate, polyethyl methacrylate, polypropyl methacrylate, polybutyl methacrylate), polycarbonate, polyethylene terphthalate (PET or PETE), propylene maleic anhydride copolymer, and any combination thereof.

At step 308, polyisobutylene (PIB) is received in the mixing vessel. The average molecular weight of the PIB received is between 110,000 g/mol and 200 g/mol. In some embodiments, the average molecular weight of the PIB received is between 2,500 g/mol and 800 g/mol. In some embodiments, the average molecular weight of the PIB received is between 1,500 g/mol and 1,600 g/mol. Exemplary PIB may include TPC 1160, Oppanol N50, Oppanol N80, Oppanol B10 SFN, Oppanol B11 SFN, Oppanol B12 SFN, Oppanol B13 SFN, Oppanol B15 SFN, Glissopal V190, Glissopal V500, Glissopal V700, Glissopal V1500, Glissopal 2300, and any combination thereof.

The average molecular weight may be determined from the average viscosity or expressed in equivalents of polystyrene (PS). When average molecular weight is determined from the average viscosity using the two following relations:

$${η}_{2} = \frac{{η}_{1} {ρ}_{2} {t}_{2}}{{ρ}_{1} {t}_{1}}$$

where the coefficient of viscosity of a liquid (η₂) is dependent upon the time of flow (t₁ and t₂) of two liquids, the density (ρ₁ and ρ₂) of the two liquids, and the coefficient of viscosity of water (η₁); and

$$[ η ] = K {M}^{α}$$

where [η] is the intrinsic viscosity, M is molecular weight, K and α are constants for a particular polymer solvent system.

When the average molecular weight is expressed in equivalents of PS, gel permeation chromatography (GPC) is used to measure the retention time that the PIB experiences as it passes through a column packed with porous beads. The time elapsed depends on the size and shape of the PIB, and the time elapsed is converted to a molecular weight through a calibration against PS because of its similar shape, polydispersity index (PDI), and known molecular weight.

At step 310, the received aromatic oil, saturated polymer, oxidized polymer, and PIB are heated and mixed to generate the polymerizing concentrate. In some embodiments, the received components are heated to between 350° F. and 450° F. In some embodiments, the received components are heated to between 370° F. and 410° F. In some embodiments, the received components are heated to between 380° F. and 400° F.

In some embodiments, the received aromatic oil, saturated polymer, oxidized polymer, and PIB are heated and mixed for between 30 minutes and 7 hours to generate the polymerizing concentrate. In some embodiments, the received components are heated and mixed for between 30 minutes and 2 hours to generate the polymerizing concentrate. In some embodiments, the received components are heated and mixed for between 1 hour and 3 hours to generate the polymerizing concentrate. In some embodiments, two stages of heating and mixing are performed, first a high shear mixing stage for between 1 hour and 3 hours with heating to between 390° F. and 410° F., then a low shear mixing stage for between 3 hours and 5 hours with heating to between 370° F. and 390° F. In one embodiment, high shear mixing is performed with a mixing head rotating at 3,500 RPM. In one embodiment, high shear mixing is performed with a rotor stator. In one embodiment, low shear mixing is performed with a mixing head rotating at 45 RPM. In one embodiment, low shear mixing is performed with a simple impeller. In one embodiment, low shear mixing is performed with an anchor agitator.

In one embodiment, steps 302 through 308 are performed simultaneously. In one embodiment, steps 302 through 308 are performed under heating and mixing. Upon completion of steps 302-310 the generated polymerizing concentrate may be stored on site at the specialty plant 301.

Generation of PMOA begins at step 312, where generated polymerizing concentrate is transported by truck from the specialty plant 301 to a receiving tank 314 at a shingle production facility.

At step 316, the shingle production facility receives oxidized asphalt (i.e., roofing flux) by train, as this is more efficient for receiving continuous bulk quantities.

At step 318, the polymerizing concentrate is transferred into a mixing vessel or processing lines containing the oxidized roofing flux. In one embodiment, this transfer may be facilitated with a Coriolis meter 319 to control the mass amount of polymerizing concentrate added to the oxidized roofing flux. In some embodiments, between 2% and 20% by weight of polymerizing concentrate is added to the oxidized roofing flux. In some embodiments, between 5% and 12% by weight of polymerizing concentrate is added to the oxidized roofing flux. In some embodiments, between 6% and 11% by weight of polymerizing concentrate is added to the oxidized roofing flux. In some embodiments, between 7% and 10% by weight of polymerizing concentrate is added to the oxidized roofing flux.

At step 320, the polymerizing concentrate and oxidized roofing flux are heated and mixed to generate a polymer modified oxidized asphalt (PMOA) roofing flux. In some embodiments, the polymerizing concentrate and oxidized roofing flux are heated to between 350° F. and 450° F. to generate a PMOA roofing flux. In some embodiments, the polymerizing concentrate and oxidized roofing flux are heated to between 370° F. and 410° F. In some embodiments, the polymerizing concentrate and oxidized roofing flux are heated to between 380° F. and 400° F.

In some embodiments, the polymerizing concentrate and oxidized roofing flux are heated and mixed for between 15 minutes and 1 hour to generate a PMOA roofing flux. In some embodiments, the polymerizing concentrate and oxidized roofing flux are heated and mixed for between 20 minutes and 40 minutes to generate a PMOA roofing flux.

### Correcting Overblown Oxidized Asphalt

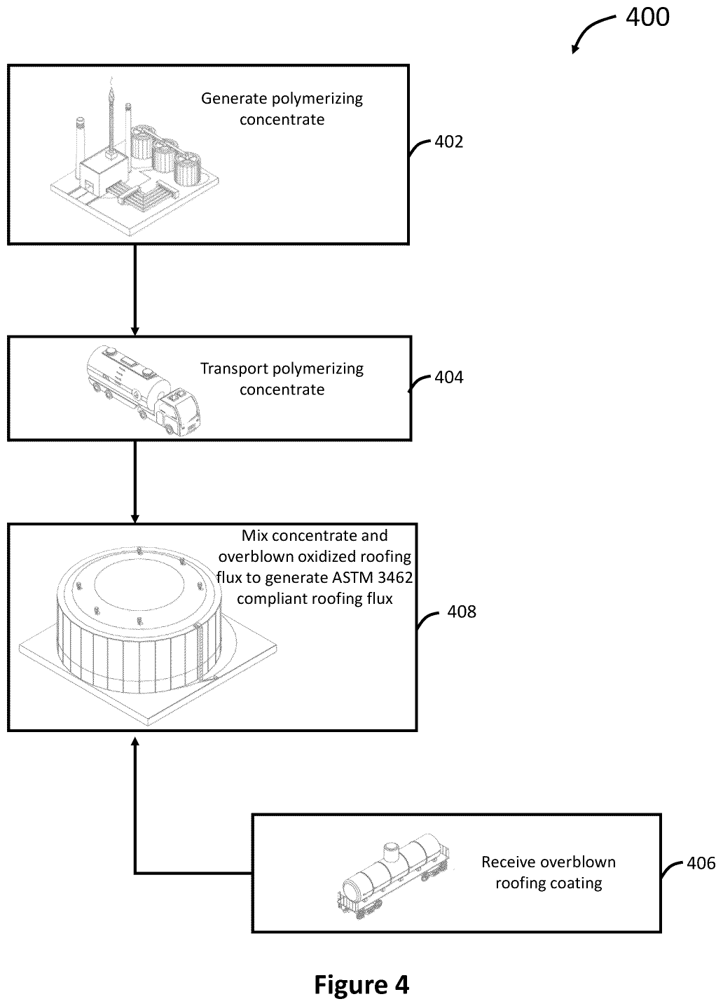

With reference now to FIG. 4, there is shown a method 400 for correcting an overblow of oxidized asphalt for roofing flux. As stated above, oxidized roofing flux must comply with ASTM D3462 requirements, which specify that the oxidized asphalt have a penetration depth of 15 dmm or higher and a softening point between 190° F. and 235° F. An overblown oxidized roofing flux misses the requirements of ASTM D3462, typically by either having a penetration depth below 15 dmm or a softening point above 235° F.

The method 400 begins at step 402, where the polymerizing concentrate is produced at a specialty plant. As described above, the polymerizing concentrate is prepared by mixing aromatic oil, saturated polymer, oxidized polymer, and PIB at between 350° F. and 450° F. for between 1 hour and 7 hours.

At step 404, the method 400 continues where the polymerizing concentrate is transported from the specialty plant to an oxidized asphalt shingle production facility. The transportation in step 404 is typically performed by truck. However, where applicable the polymerizing concentrate may be transported by train or by pipe directly from the specialty plant to the oxidized asphalt shingle production facility. In a further embodiment, the polymerizing concentrate is produced on site at the oxidized asphalt shingle production facility and transferred into a mixing vessel or line on site.

At step 406, overblown oxidized asphalt roofing flux is received at the oxidized asphalt shingle production facility. In a typical embodiment, the overblown oxidized asphalt roofing flux is received via train, but may be received by truck, direct pipe or any other commercially viable transportation method.

At step 408, the overblown oxidized asphalt roofing flux is mixed under heating with the polymerizing concentrate to correct the overblowing. This addition of polymerizing concentrate has the effect of both increasing the penetration depth and decreasing the softening point of the overblown oxidized asphalt roofing flux. This correction is effected through the addition of between 0.01% and 2% by weight of polymerizing concentrate to the overblown oxidized asphalt roofing flux. The resulting mixture is termed a “corrected oxidized asphalt roofing flux”. In some embodiments, between 0.5% and 1.5% by weight of polymerizing concentrate is added to the overblown oxidized asphalt roofing flux to generate the corrected oxidized asphalt roofing flux.

In some embodiments, the polymerizing concentrate and overblown oxidized asphalt roofing flux are heated during mixing to between 350° F. and 450° F. to generate corrected oxidized asphalt roofing flux. In some embodiments, the polymerizing concentrate and overblown oxidized asphalt roofing flux are heated during mixing to between 370° F. and 420° F. to generate corrected oxidized asphalt roofing flux. In some embodiments, the polymerizing concentrate and overblown oxidized asphalt roofing flux are heated during mixing to between 380° F. and 410° F. to generate corrected oxidized asphalt roofing flux. In some embodiments, the polymerizing concentrate and overblown oxidized asphalt roofing flux are heated and mixed for between 15 minutes and 1 hour to generate corrected oxidized asphalt roofing flux. In some embodiments, the polymerizing concentrate and overblown oxidized asphalt roofing flux are heated and mixed for between 20 minutes and 40 minutes to generate corrected oxidized asphalt roofing flux.

### Compositions of Matter

The polymerizing concentrate described herein is a homogenous mixture of saturated polymer, oxidized polymer, and PIB, all dissolved in aromatic oil. In some embodiments, the polymerizing concentrate includes between 50% and 75% by weight aromatic oil, between 5% and 15% by weight saturated polymer, between 1% and 5% by weight oxidized polymer, and between 20% and 30% by weight PIB. In one embodiment, the polymerizing concentrate includes 62% by weight aromatic oil, 10% by weight saturated polymer, 3% by weight oxidized polymer, and 25% by weight PIB. In one embodiment, the polymerizing concentrate includes 1) a heavy aromatic oil that is at least 90% by weight aromatic hydrocarbons and up to 10% by weight saturated hydrocarbons; 2) SEBS; 3) oxidized high density polyethylene; and 4) PIB.

In some embodiments, the saturated polymer is SEBS having an average molecular weight ranging from 10,000 g/mol to 30,000 g/mol. In one embodiment, the SEBS has an average molecular weight ranging from 18,000 g/mol to 22,000 g/mol. In some embodiment, the PIB has an average molecular weight ranging from 200 g/mol to 110,000 g/mol. In one embodiment, the PIB has an average molecular weight ranging from 1,000 g/mol to 2,300 g/mol. In one embodiment, the PIB has an average molecular weight ranging from 1,500 g/mol to 1,600 g/mol.

Table 1 below shows the composition of particular preparations of the polymerizing concentrate.

TABLE 1
Polymerizing Concentrate Sample Compositions

| | | Saturated | Oxidized | PIB |
|---|---|---|---|---|
| Sample | Aromatic | Polymer | Polymer | [avg. g/mol] |
| ID | Oil (g) | (g) | (g) | (g) |
| 210412-03 | Hydrolene | SEBS | Oxidized | Glissopal V 190 |
| | (403.0) | (65.0) | polyethylene | [1,000] (162.5) |
| | | | (19.5) | |
| 210512-30 | Hydrolene | SEBS | Oxidized | Glissopal V 190 |
| | (403.0) | (65.0) | polyethylene | [1,000] (162.5) |
| | | | (19.5) | |
| 210512-60 | Hydrolene | SEBS | Oxidized | Glissopal V 500 |
| | (403.0) | (65.0) | polyethylene | [1,300] (162.5) |
| | | | (19.5) | |
| 210120-01 | Hydrolene | SEBS | Oxidized | TPC 1160 |
| | (310.0) | (50.0) | polyethylene | [1,550] (125.0) |
| | | | (15.0) | |
| 221013-20 | Hydrolene | SEBS | Oxidized | TPC 1160 |
| | (403.0) | (65.0) | polyethylene | [1,550] (162.5) |
| | | | (19.5) | |
| 210412-04 | Hydrolene | SEBS | Oxidized | Glissopal V 700 |
| | (403.0) | (65.0) | polyethylene | [1,600] (162.5) |
| | | | (19.5) | |
| 210512-40 | Hydrolene | SEBS | Oxidized | Glissopal V 700 |
| | (403.0) | (65.0) | polyethylene | [1,600] (162.5) |
| | | | (19.5) | |
| 210412-05 | Hydrolene | SEBS | Oxidized | Glissopal V 1500 |
| | (403.0) | (65.0) | polyethylene | [2,300] (162.5) |
| | | | (19.5) | |
| 210512-50 | Hydrolene | SEBS | Oxidized | Glissopal V 1500 |
| | (403.0) | (65.0) | polyethylene | [2,300] (162.5) |
| | | | (19.5) | |
| 210510-02 | Hydrolene | SEBS | Oxidized | Glissopal 2300 |
| | (403.0) | (65.0) | polyethylene | [2,300] (162.5) |
| | | | (19.5) | |
| 210512-70 | Hydrolene | SEBS | Oxidized | Glissopal 2300 |
| | (403.0) | (65.0) | polyethylene | [2,300] (162.5) |
| | | | (19.5) | |
| 210205-01 | Hydrolene | SEBS | Oxidized | Oppanol B 10 SFN |
| | (403.0) | (65.0) | polyethylene | [40,000]* (162.5) |
| | | | (19.5) | |
| 210205-02 | Hydrolene | SEBS | Oxidized | Oppanol B 11 SFN |
| | (403.0) | (65.0) | polyethylene | [47,000] (162.5) |
| | | | (19.5) | |
| 210205-03 | Hydrolene | SEBS | Oxidized | Oppanol B 12 SFN |
| | (403.0) | (65.0) | polyethylene | [55,000]* (162.5) |
| | | | (19.5) | |
| 210512-20 | Hydrolene | SEBS | Oxidized | Oppanol B 12 SFN |
| | (403.0) | (65.0) | polyethylene | [55,000]* (162.5) |
| | | | (19.5) | |
| 210125-04 | Hydrolene | SEBS | Oxidized | Oppanol B 15 |
| | (403.0) | (65.0) | polyethylene | [85,000]* (162.5) |
| | | | (19.5) | |

*Values are average molecular weights based on relative viscosity; average molecular expressed in equivalents of polystyrene may be larger

Table 2 below shows certain physical properties (i.e., viscosity, penetration depth, softening point, and flash point) of particular preparations of the polymerizing concentrate.

TABLE 2
Physical Properties for Polymerizing Concentrate Samples

| | Viscosity @ | | Softening | Flash |
|---|---|---|---|---|
| | 350° F., | Penetration, | Point, | Point, |
| Sample ID | cP | dmm | ° F. | ° F. |
| 210412-03 | 218 | 98 | 206 | 565 |
| 210512-30 | 214 | 83 | 216 | N/A |
| 210512-60 | 243 | 93 | 238 | N/A |
| 210120-01 | 269 | 98 | 211 | 560 |
| 221013-20 | 262 | 92 | 239 | 520 |
| 210412-04 | 275 | 96 | 223 | 560 |
| 210512-40 | 272 | 96 | 235 | N/A |
| 210412-05 | 323 | 91 | 223 | 565 |
| 210512-50 | 294 | 98 | 244 | N/A |
| 210510-02 | 278 | 92 | 239 | 580 |
| 210512-70 | 304 | 93 | 242 | N/A |
| 210205-01 | 1,494 | 196 | 246 | 590 |
| 210205-02 | 2,013 | 198 | 246 | 586 |
| 210205-03 | 2,528 | 198 | 244 | 588 |
| 210512-20 | 2,346 | 93 | 245 | N/A |
| 210125-04 | 5,363 | 180 | 246 | 590 |

The polymer modified oxidized asphalt (“PMOA”) described herein is a homogenous mixture of oxidized asphalt and the polymerizing concentrate. In some embodiments, the PMOA includes between 2% and 20% by weight polymerizing concentrate. In some embodiments, the PMOA includes between 5% and 12% by weight polymerizing concentrate. In one embodiment, the PMOA includes 7% by weight polymerizing concentrate. In one embodiment, the PMOA includes 10% by weight polymerizing concentrate.

Table 3 below shows certain physical properties (i.e., viscosity, penetration depth, softening point, and flash point) of PMOA mixtures generated from oxidized asphalt and the polymerizing concentrate.

TABLE 3
Physical Properties for PMOA Samples

| | Polymerizing | | | Softening |
|---|---|---|---|---|
| | Concentrate, | Viscosity @ | Penetration, | Point, |
| Sample ID | % Content | 400° F., cP | dmm | ° F. |
| 210412-03 | 7 | 470 | 17 | 213 |
| 210412-03 | 10 | 454 | 19 | 212 |
| 210512-30 | 7 | 412 | 18 | 217 |
| 210512-30 | 10 | 454 | 18 | 221 |
| 210512-60 | 7 | 509 | 18 | 223 |
| 210512-60 | 10 | 448 | 17 | 219 |
| 210120-01 | 7 | 547 | 17 | 223 |
| 210120-01 | 10 | 554 | 19 | 223 |
| 221013-20 | 7 | 346 | 20 | 201 |
| 221013-20 | 7 | 461 | 24 | 211 |
| 221013-20 | 10 | 339 | 22 | 203 |
| 221013-20 | 10 | 435 | 28 | 209 |
| 210412-04 | 7 | 502 | 17 | 215 |
| 210412-04 | 10 | 464 | 18 | 214 |
| 210512-40 | 7 | 442 | 17 | 219 |
| 210512-40 | 10 | 454 | 18 | 220 |
| 210412-05 | 7 | 496 | 17 | 215 |
| 210412-05 | 10 | 506 | 17 | 216 |
| 210512-50 | 7 | 502 | 16 | 223 |
| 210512-50 | 10 | 499 | 17 | 223 |
| 210510-02 | 7 | 474 | 17 | 215 |
| 210510-02 | 10 | 486 | 18 | 222 |
| 210512-70 | 7 | 451 | 18 | 220 |
| 210512-70 | 10 | 486 | 17 | 222 |
| 210205-03 | 7 | 880 | 18 | 235 |
| 210512-20 | 7 | 803 | 17 | 235 |
| 210125-04 | 7 | 883 | 17 | 233 |

The PMOA compositions presented herein include an oxidized shingle coating that has physical characteristics that include an appropriate viscosity for handling and processing as a shingle coating in a shingle production plant, a low penetration within the requirements of ASTM D3462 (i.e., >15 dmm), and a low softening point that meets ASTM D3462 requirements (i.e., 190 F to 235° F.).

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A method for generating a polymer modified oxidized asphalt comprising:
receiving a plurality of polymerizing concentrate components including an aromatic oil, a saturated polymer, an oxidized polymer, and polyisobutylene (“PIB”);
mixing and heating the plurality of polymerizing concentrate components to between 350° F. and 450° F. for one (1) to seven (7) hours to generate a polymerizing concentrate;
receiving an oxidized asphalt;
adding 2% to 20% by weight of the polymerizing concentrate to the oxidized asphalt; and
heating the oxidized asphalt and the polymerizing concentrate to between 350° F. and 450° F. for between 15 minutes and one hour to generate the polymer modified oxidized asphalt.

2. The method of claim 1 wherein the plurality of concentrate components are heated to between 370° F. and 410° F.

3. The method of claim 1 wherein the plurality of concentrate components are mixed with heating for 1 hour to 3 hours.

4. The method of claim 1 wherein the PIB comprises an average molecular weight ranging from 200 g/mol to 110,000 g/mol.

5. The method of claim 1 wherein the PIB comprises an average molecular weight ranging from 800 g/mol to 2,300 g/mol.

6. The method of claim 1 wherein the saturated polymer includes SEBS.

7. The method of claim 1 wherein the polymerizing concentrate further comprises:
50% to 75% by weight aromatic oil;
5% to 15% by weight saturated polymer;
1% to 5% by weight oxidized polymer; and
20% to 30% by weight PIB.

8. The method of claim 1 further comprising adding 5% to 12% by weight of the polymerizing concentrate to the oxidized asphalt.

9. A polymer modified oxidized asphalt composition comprising:
a polymerizing concentrate including:
50% to 75% by weight of an aromatic oil;
5% to 15% by weight of a saturated polymer;
1% to 5% by weight of an oxidized polymer;
20% to 30% by weight of polyisobutylene (“PIB”); and
an oxidized asphalt.

10. The composition of claim 9 comprising between 2% and 20% by weight of the polymerizing concentrate.

11. The composition of claim 9 comprising between 5% and 12% by weight of the polymerizing concentrate.

12. The composition of claim 9 wherein the saturated polymer includes SEBS.

13. The composition of claim 9 wherein the PIB comprises an average molecular weight ranging from 200 g/mol to 110,000 g/mol.

14. The composition of claim 9 wherein the PIB comprises an average molecular weight ranging from 800 g/mol to 2,300 g/mol.

15. A method of operating a system for generating polymer modified oxidized asphalt comprising:
receiving a flow of oxidized asphalt;
injecting a polymerizing concentrate into the flow of oxidized asphalt, wherein the polymerizing concentrate comprises:
an aromatic oil;
a saturated polymer;
an oxidized polymer; and
polyisobutylene; and
heating the flow of oxidized asphalt and the polymerizing concentrate to between 350° F. and 450° F. for between 1 hour and 7 hours to generated the polymer modified oxidized asphalt.

16. The method of claim 15 wherein the PIB comprises an average molecular weight ranging from 800 g/mol to 2,300 g/mol.

17. The method of claim 15 wherein the polymerizing concentrate further comprises:
50% to 75% by weight aromatic oil;
5% to 15% by weight saturated polymer;
1% to 5% by weight oxidized polymer; and
20% to 30% by weight PIB.

18. The method of claim 15 further comprising adding 5% to 12% by weight of the polymerizing concentrate to the oxidized asphalt.

19. The method of claim 15 wherein the saturated polymer includes SEBS.

20. The method of claim 15 wherein the PIB comprises an average molecular weight ranging from 200 g/mol to 110,000 g/mol.
